(19) United States
(12) Patent Application Publication
(10) Pub. No.: US 2017/0140470 A1
(43) Pub. Date: May 18, 2017

(54) REAL-TIME DATA OBJECT ASSOCIATIONS

(71) Applicant: SAP SE, Walldorf (DE)

(72) Inventor: Zhiqiang Wu, Shanghai (CN)

(21) Appl. No.: 14/945,272

(22) Filed: Nov. 18, 2015

(51) Int. Cl. G06Q 40/00; G06F 17/30

(52) U.S. Cl. CPC G06Q 40/12; G06F 17/30604; G06F 17/3056

(57) ABSTRACT

An indirect data object association module performs an indirect data object association based on detecting a user interaction with an interface for determining data objects associated with a selected data object. The module generates a direct association interface object that lists data objects directly associated with the selected data object and accesses data corresponding to data objects associated with the data objects listed in the direct association interface object. An indirect data object association is performed based on the selected data object, its directly associated data objects and the accessed data. The module generates an indirect association interface object to list data objects indirectly associated with the selected data object and links the indirect association interface object to the direct association interface object. A periodic indirect data object association report is generated for multiple data objects based on respective indirect association interface objects for each of the multiple data objects.

### TECHNICAL FIELD

The present disclosure relates generally to defining associations between data objects in real-time and, in a specific example embodiment, to the use of individual real-time data object associations in order to avoid large batch associations for groups of data objects at periodic intervals resulting in spikes in the use of system resources.

### BACKGROUND

Organizing large sets of data so that related data objects are properly associated is a common problem. Sometimes the determination of the associations between the data objects is required a periodic intervals. For example, with regard to the overhead costs required to run a business, but which cannot be directly attributed to any specific business activity, product, or service. The allocation of certain overhead costs to produced goods is required under the rules of various accounting frameworks. For most businesses, the overhead allocation for a group of products is usually part of an end-of-period accounting process for the accounting period during which the group of products is produced. However, it can be useful to allocate or assign overhead costs to specific products and/or services outside of any required financial statements. For example, most enterprise systems are in constant use and will see their performance affected during an end-of-period accounting process that is often a cumbersome process that runs across several applications and data sets resulting in the need to perform many data transfers. The end-of-period accounting processes can include long-running batch processes that are run sequentially due to the distributed storage of master data and transactional data resulting in a large spike in the use of system resources during the end-of-period accounting processes.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of a business system in which example embodiments of the disclosed subject matter may be practiced.

FIG. 2 is an example graphical user interface, in accordance with example embodiments, for determining the actual cost of producing a product or providing a service.

FIG. 3 is a block diagram illustrating an overhead cost allocation module, in accordance with example embodiments, for performing real-time overhead cost allocations.

FIG. 4 is a block diagram showing the allocation engine of FIG. 3 in more detail.

FIGS. 5A and 5B show a ladder diagram illustrating the dataflow, in accordance with example embodiments, for providing real-time overhead cost allocations.

FIGS. 6A and 6B are flowcharts of an example methods, in accordance with example embodiments, for providing real-time data object associations and real-time overhead cost allocations respectively.

FIG. 7 is a flowchart of an example method, in accordance with example embodiments, for providing real-time overhead cost allocations.

FIG. 8 is a block diagram of a machine in the example form of a computer system within which instructions for causing the machine to perform any one or more of the methodologies discussed herein can be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter can be practiced without these specific details. In general, well-known instruction instances, protocols, structures, and techniques have not been shown in detail.

Systems and methods for providing real-time indirect association of data objects are described. In example embodiments, an indirect data object association module detects a trigger to perform an indirect data object association based on a machine user's interaction with a graphical user interface for determining data objects associated with a selected data object. The trigger might be, for example, a direct user association of a data object to the selected data object. The indirect data object association module then generates a direct association interface object accessible in the graphical user interface. The direct association interface object lists the data objects directly associated with the selected data object. Data regarding data objects associated with the data objects listed in the direct association interface object is accessed from coupled storage (e.g., via network connection to machine). In other words, data corresponding to data objects that are only indirectly related to the selected data object (e.g., overhead costs) is accessed. An indirect data object association is then performed based on the selected data object, the data objects directly associated with the selected data object and the accessed data. The indirect data object association module generates an indirect association interface object to list data objects that are indirectly associated with the selected data object and links the indirect association interface object to the direct association interface object.

Systems and methods for providing real-time indirect association of data objects comprising real-time allocation of overhead costs to the total cost of a product or service are provided. In example embodiments, an overhead cost allocation module detects a trigger to perform an overhead cost allocation based on a machine user's interaction with a graphical user interface for determining a total cost of producing a product or providing a service. The trigger might be, for example, a user allocation of a direct cost to the total cost of producing the product. The overhead cost allocation module then generates a direct cost interface object accessible in the graphical user interface. The direct cost interface object lists the costs directly attributable to the production of the product. Overhead cost data corresponding to the direct costs listed in the direct cost interface object is accessed from coupled storage (e.g., via network connection to machine) and an overhead cost allocation is then performed based on the direct costs associated with producing the product and the corresponding overhead cost data. The overhead cost allocation module generates an overhead cost interface object to list overhead costs associated with producing the product and links the overhead cost interface object to the direct cost interface object.

As such, example embodiments allow for real-time overhead cost allocations for planning and decision support in regard to the profitability of specific products. This product-specific overhead cost information can remain internal to a business to assist management with decisions such as pricing, choice of products to produce or phase out of production, choice of products to review for production process changes, etc. Ultimately, it should be possible to know whether each product's selling price is adequate to cover the product's manufacturing costs, overhead costs and any required profit. The real-time overhead cost allocation may also allow for customization based on a user change to a portion of the real-time overhead cost allocation process. For example, with respect to determining the true “cost” of producing a product, the real-time overhead cost allocation process may allow for customizing how overhead manufacturing expenses (e.g., factory maintenance) are allocated to specific product costs. For example, if an overhead labor cost (e.g., salary of factory maintenance worker) is not being allocated to a specific product at a cost center, a user may desire to determine the product cost based on allocation of the salary as an overhead cost to the product cost.

In another example, a user may want to determine the product cost with a new higher price of a raw material used in producing the product. In this situation, the user can simply overwrite the overhead cost data with respect to the cost of the raw material to see the effects of an increase in raw material cost on product cost. Furthermore, the input for customizing the real-time overhead cost allocation may be provided by various individuals in the business/organization. For instance, a manager in charge of efficiency in production can determine an impact of running machines faster (e.g., less time in a cost center to produce a unit) on the product cost. These are only some examples of forward real-time overhead allocations capable of being performed by example embodiments of the presently disclosed subject matter.

Backward calculations (e.g., reversing or deleting erroneous cost transactions including associated overhead cost allocations) may also be performed by example embodiments to reverse the allocation of overhead costs. For example, reversing the overhead cost allocation may result from a failed transaction (e.g., check does not clear) for which cost allocations that have already been made must now be reversed. The reversal of a real-time overhead cost allocation can include the calculation of an offsetting overhead cost allocation. For example, an offsetting overhead cost allocation is determined including costs with opposite positive/negative signs with respect to the original real-time cost allocation being reversed. In the reversed overhead cost allocation, for every listed overhead cost being allocated in the original real-time cost allocation, the system creates a corresponding cost item with the opposite positive/negative sign.

Example embodiments also allow for collaboration between different individuals of an organization (e.g., business entity). Because example embodiments can provide real-time overhead cost allocations with respect to a single product, these individuals may work together (to customize the allocation parameters) and immediately see the impact of a change on the final product. For example, if the user specifies a price increase for raw material, the product will become more expensive. The business may want to adjust for this price increase by, for example, decreasing time needed in production (e.g., increasing efficiency or changing product design to use different raw material). Thus, example embodiments allow for the running of these customized real-time overhead cost allocations to help the business determine optimal procedures.

By using embodiments of the present invention, a real-time overhead cost allocation may be performed for each product being produced. Accordingly, one or more of the methodologies discussed herein may obviate a need for separate batch processing of all overhead cost data associated with products produced during an accounting period, which may have the technical effect of reducing spikes in the use of computing resources used by one or more devices within the system. This is due to the spreading of the computing resources used for overhead cost allocations across the time of the accounting period instead of doing all of the allocations together at the end of the accounting period. Examples of such computing resources include, without limitation, processor cycles, network traffic, memory usage, storage space, and power consumption. Thereafter, an overhead cost allocation report for multiple products produced during the accounting period may be produced based on overhead costs listed in the respective real-time overhead cost allocations of the multiple products.

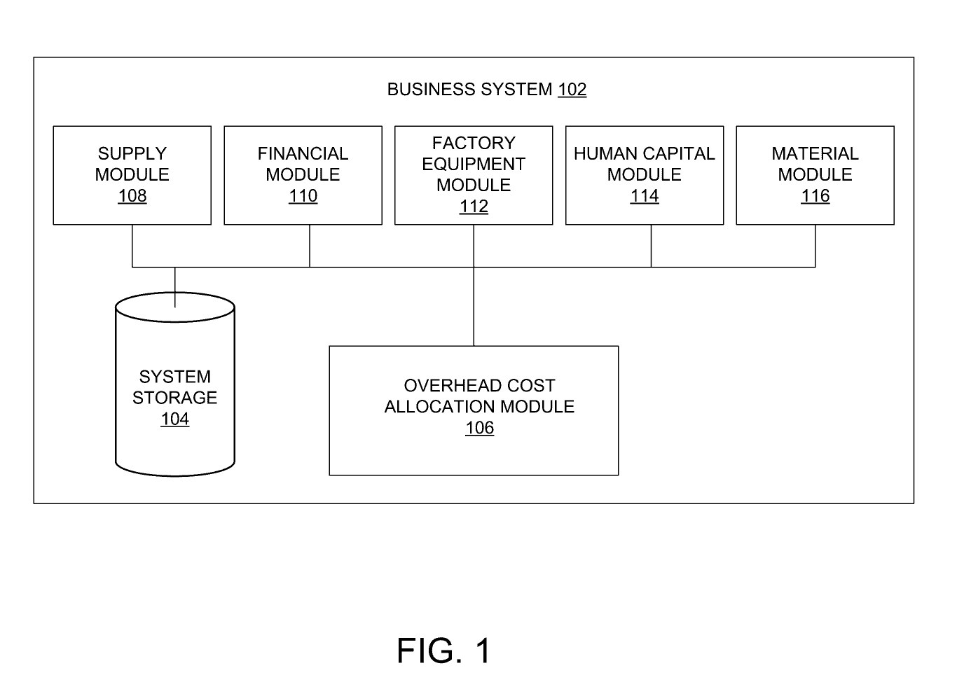

FIG. 1 is a block diagram of a business system in which example embodiments of the disclosed subject matter may be practiced. The business system 102 includes multiple modules communicatively coupled to an overhead cost allocation module 106. The business system 102 may be located at a location of a business or customer and manages data specific to the business needs of the customer. For example, the business system 102 may comprise a customer enterprise resource planning (ERP) system. However, business system 102 may comprise any cost management system providing data to overhead cost allocation module 106.

In example embodiments, the modules of business system 102 are communicatively linked via a network such as: the Internet, a wireless network, a cellular network, a Wide Area Network (WAN), or any other type of network which allows for exchange of communications.

In example embodiments, the modules of business system 102 represent a plurality of different departments of a business that contribute cost data to the overhead cost allocation module 106. A system storage 104 is also provided, e.g., database(s). The modules may comprise, for example, supply module 108, financial module 110, factory equipment module 112, human capital module 114, and material module 116. These are merely examples and other modules may be provided in business system 102.

In example embodiments, the overhead cost allocation module 106 detects a trigger to perform an overhead cost allocation. Detecting the trigger may comprise detecting a user interaction with a graphical user interface (of business system 102) for determining a total cost of producing a product or providing a service. The trigger might be, for example, a user of the human capital module 114 allocating the cost of a worker's salary to the total cost of producing the product. The overhead cost allocation module 106 will then, based on data from the modules of business system 102, generate a direct cost interface object accessible in the graphical user interface. The direct cost interface object lists the costs directly attributable to the production of the product, e.g., like the worker salary being allocated). Overhead cost data (e.g., based on historical expenses since actual costs are unlikely to be available) corresponding to the direct costs listed in the direct cost interface object is then accessed from the coupled modules of business system 102 (e.g., cost to train the worker) and an overhead cost allocation is then performed based on the direct costs associated with producing the product and the corresponding overhead cost data. An overhead cost interface object is generated to list the costs not directly attributable to the production of the product.

In one embodiment, the business system 102 may be part of an on-demand system which is hosted by a service provider. The on-demand system comprises one or more network applications that provide services and support to a customer (e.g., business) without the customer having to host the system on their premises. That is, the service provider hosts (e.g., offers, provides, implements, executes, or performs one or more operations of) the systems and the customer can assess functionalities online through a software-as-a-service (SaaS) model. The business system 102 of FIG. 1 is merely an example and alternative embodiments may comprise any number of business system(s) 102 (each including any number of modules) communicatively coupled to each other. Furthermore, modules and functions of the business system 102 may be combined, separated, or located elsewhere in the business system 102.

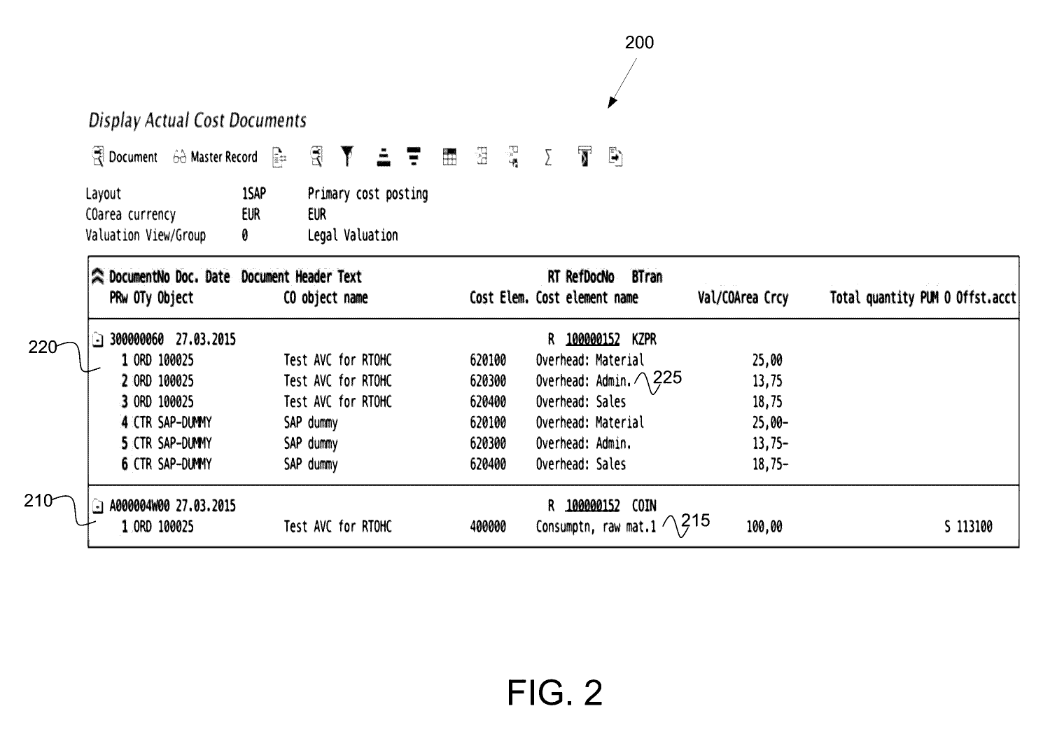

FIG. 2 is a block diagram illustrating an example graphical user interface 200 for determining and displaying the actual cost for producing a product or providing a service. As noted above, the trigger for a real-time overhead cost allocation may be any cost management transaction by a user of business system 102 via graphical user interface 200, for example, a “raw material consumption” transaction (Business Transaction 100000152) associated with the production of a specific product. The overhead cost allocation module 106 may, based on the detection of such a trigger transaction, generate a direct cost interface object 210 that lists direct manufacturing costs (e.g., raw material 215) associated with the triggering transaction 100000152. A real-time overhead cost allocation can then be performed immediately after the generation of the direct cost interface object 210. A separate overhead cost interface object 220 is then generated which lists overhead costs (e.g., administration costs 225) associated (e.g., based on data from the modules of business system 102) with the direct costs listed in the direct cost interface object 210 generated for the “raw material consumption” transaction 100000152. The overhead cost interface object 220 is linked to the direct cost interface object 210 of the “raw material consumption” transaction for easy future reference (e.g., financial accounting). For example, the linked interface objects could then be saved together (e.g., to system storage 104) within one logical data structure to ensure that all linked interface objects are saved, deleted or otherwise manipulated (e.g., checking or editing) together or not at all. In this way, errors resulting from uncoordinated manipulation of related data objects can be avoided. As noted above, the parameters of the real-time overhead allocation may be modified via user input and user interface 200 can provide options for such modifications. For example, allowing the user to remove an overhead cost (e.g., administration costs 225) that has been allocated to a direct cost (e.g., raw material 215) of the originating “raw material consumption” transaction 100000152. Periodic overhead allocation (e.g., end of accounting period) for this “raw material consumption” transaction 100000152 can then be omitted.

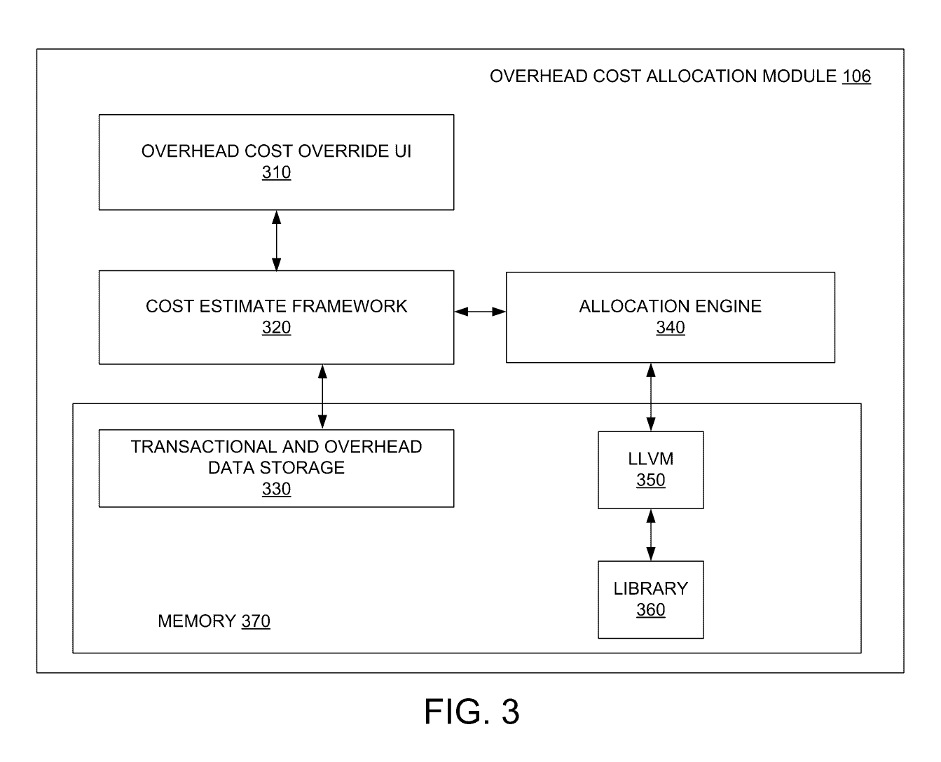

FIG. 3 is a block diagram illustrating an overhead cost allocation module 106, in accordance with example embodiments, for performing real-time overhead cost allocations. The overhead cost allocation module 106 may be implemented, for example, in an SAP enterprise resource planning (ERP) environment. In accordance with example embodiments, the overhead cost allocation module 106 comprises an overhead cost override user interface (UI) 310, a cost estimate framework 320, and memory 370. The overhead cost override UI 310 provides a front end for the user to provide data to, and access data from, the memory 370 and, in one embodiment, provides a graphical user interface 200 for this exchange of data.

The cost estimate framework 320 assembles the data from different sources (e.g., from the modules 108-116 of business system 102 or from user input) into a single overhead cost allocation and also generates data queries to retrieve additional data from these different sources into the transactional and overhead data storage 330 (in the memory 370) for use in the overhead cost allocation. Necessary calculations may be performed in an allocation engine 340. The assembled data discloses, for example, relationships between cost centers, activities, cost drivers, processes, materials, semi-finished products, and finished products (e.g., a specific product needs five hours from a specific cost center) and may be imported into the transactional and overhead data storage 330 for use in the real-time overhead cost allocation.

Furthermore, the cost estimate framework 320 determines entities (e.g., cost centers, products, activities) and their relationships with respect to specified rules for overhead allocation, e.g., a product can consume an activity from a cost center whereby an overhead cost allocation formula for a product may be: overhead cost value=overhead rate*activity quantity, for each activity consumed by the product. These relationships may be modeled as systems of linear equations by the allocation engine 340. By using linear equations, forward calculations (e.g., from cost center expenses and purchase prices to product cost) as well as backward calculations (e.g., from previously determined overhead cost allocation in order to reverse the allocation of overhead costs to a product) can be executed. The linear equations may be solved by numeric algorithms, for example, stored in a library 360, e.g., the International Mathematics and Statistics Library—IMSL. While the present embodiment shows the library 360 being located within the memory 370 and coupled to the allocation engine 340 via a low-level virtual machine (LLVM) 350, alternative embodiments may have the library 360 located outside of the memory 370 but coupled thereto.

As noted above, the cost estimate framework 320 assembles data for the overhead cost allocation. The cost estimate framework 320 also detects the trigger (e.g., user transaction) to perform the overhead cost allocation. The cost estimate framework 320 further provides the data assembled in the transactional and overhead data storage 330 to the overhead cost override UI 310. The data presented to the overhead cost override UI 310 may be overwritten or deleted by a user via, for example, a user interface 200 provided by the overhead cost override UI 310.

The cost estimate framework 320 may detect a user interaction with a graphical user interface 200 (of business system 102) for determining a total cost of producing a product or providing a service. The cost estimate framework 320 will then, based on the assembled data in transactional and overhead data storage 330, generate a direct cost interface object 210 accessible in the graphical user interface 200. The direct cost interface object 210 lists the costs directly attributable to the production of the product. Overhead cost data (e.g., based on historical expenses since actual costs are unlikely to be available) corresponding to the direct costs listed in the direct cost interface object 210 has also been assembled (e.g., by cost estimate framework 320) in transactional and overhead data storage 330 and an overhead cost allocation is performed by allocation engine 340 based on the direct costs associated with producing the product and the corresponding overhead cost data. An overhead cost interface object 220 is generated to list the costs not directly attributable to the product. The overhead cost interface object 220 may be presented to the user via the overhead cost override UI 310.

The allocation engine 340 executes other planning functions such as, for example, linking the overhead cost interface object 220 to the direct cost interface object 210 for easy future reference. As noted above, the linked interface objects could then be saved together within one logical data structure to ensure that the linked interface objects (and any other linked objects) are saved, deleted or otherwise manipulated (e.g., checking or editing) together or not at all. The results are then returned to the cost estimate framework 320 and may be stored in the memory 370 (e.g., the transactional and overhead data storage 330). The results may also be displayed in the front end, for example, by the user interface 200 provided by the overhead cost override UI 310. Thereafter, the allocation engine 340 may generate an overhead cost allocation report for multiple products produced during an accounting period (e.g., required financial accounting) based on overhead costs listed in the respective real-time overhead cost allocations of the multiple products.

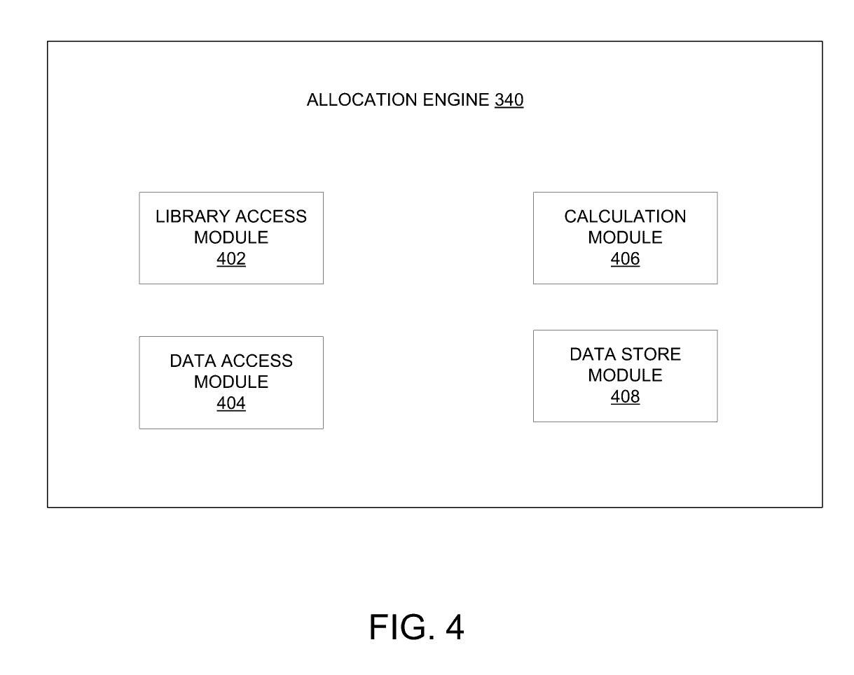

FIG. 4 is a block diagram showing the allocation engine 340 of FIG. 3 in more detail. The allocation engine 340 manages the processing in the overhead cost allocation module 106. To this end, the allocation engine 340 comprises a library access module 402, a data access module 404, a library access module 402, a calculation module 406, and a data store module 408 communicatively coupled together. The library access module 402 receives the algorithms for processing from the library 360 (within the memory 370) via the low-level virtual machine (LLVM) 350. In example embodiments, the LLVM 350 accesses and reads the algorithms from the library 360 and provides the algorithms to the library access module 402.

Given the algorithms, the allocation engine 340 determines the data needed to perform the processing. Accordingly, the data access module 404 accesses and retrieves the extracted data (e.g., required for linear equation parameterizations) stored in the transactional and overhead data storage 330 and any input data from the user (e.g., in the case of a user override) via the overhead cost override UI 310. The calculation module 406 performs the corresponding calculations (e.g., solve linear equations) and the results are returned to the data store module 408. Subsequently, the data store module 408 stores the results back to the transactional and overhead data storage 330. In some embodiments, the overhead cost override UI 310 accesses the results in the transactional and overhead data storage 330 and displays the results to the user.

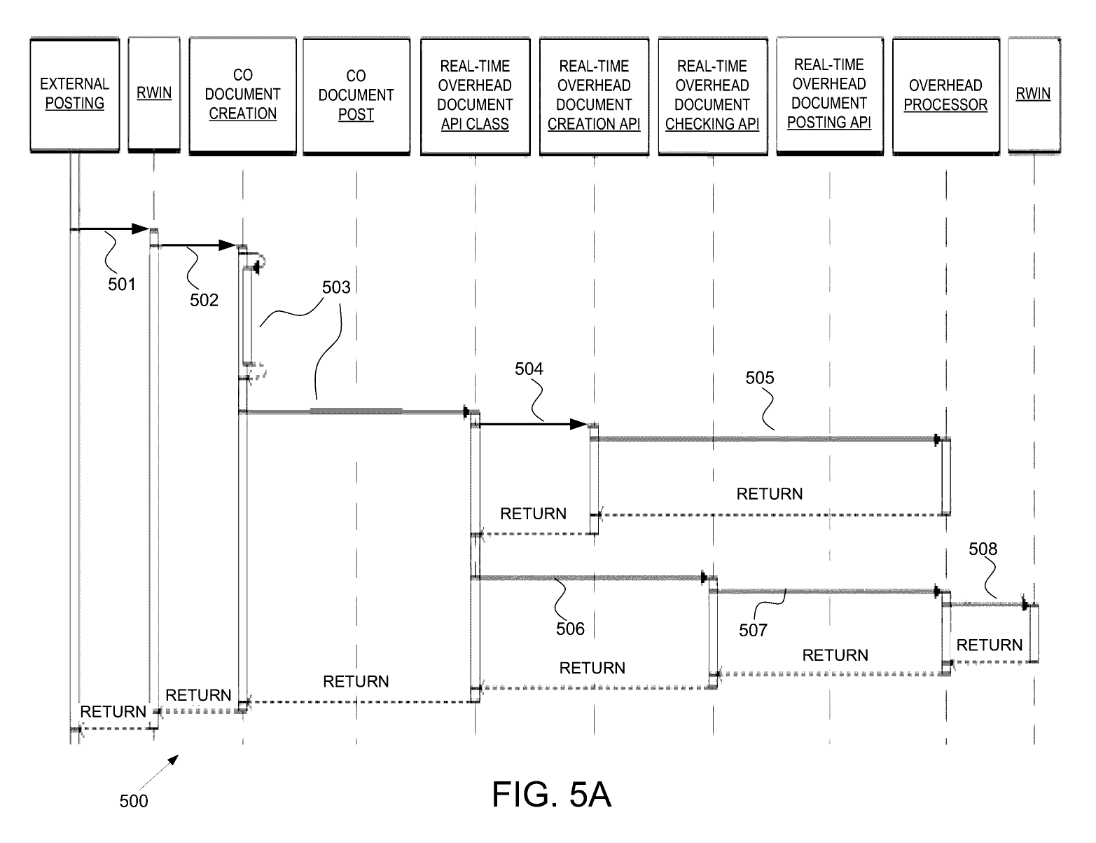

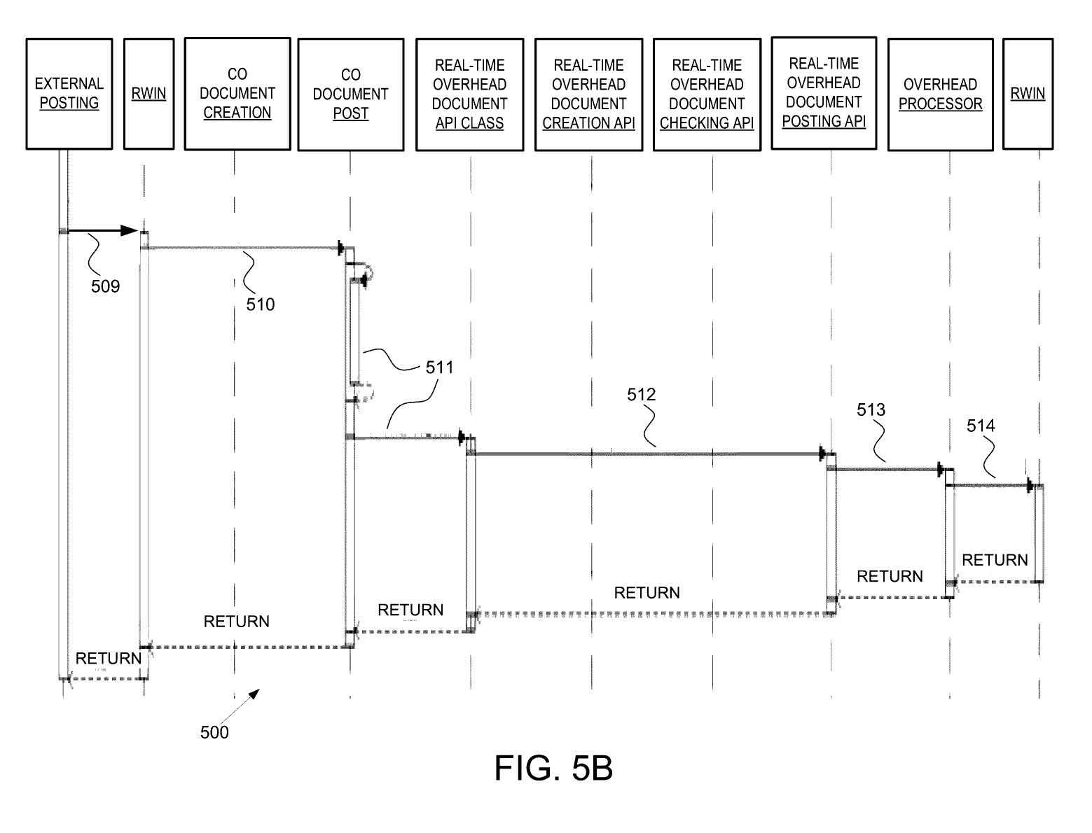

FIGS. 5A and 5B show a ladder diagram 500 illustrating the dataflow, in accordance with example embodiments, for providing real-time overhead cost allocations.

In regard to FIG. 5A, at operation 501, a user allocates, via an external posting (e.g., from a financial accounting component) to a CO component (Controlling component) for posting direct costs/expenses, a cost to a data object (e.g., representing a product or service transaction) so that first the process BELEG and event PROJECT of the accounting interface RWIN will be triggered. In operation 502, the accounting interface RWIN calls function CO_DOCUMENT_PROJECT to create the CO document (e.g. direct cost interface object 210) for this posting. This may be detected as a trigger to perform an overhead cost allocation. The triggering CO actual document might be, for example, a user allocation of a direct cost (e.g., raw material cost) to the total cost of producing the product or providing the service. In operation 503, the function CO_DOCUMENT_PROJECT first creates the CO document for the posting, and then calls method CREATE of class CL_FINS_RTOHC_DOC to create an associated real-time overhead document, e.g. overhead cost interface object 220.

In operation 504, the method CREATE of class CL_FINS_RTOHC_DOC calls function RTOHC_DOCUMENT_CREATE to create the real-time overhead document, for example, because a Real-time Overhead Calculation function was switched on in a customizing step by the user. IN operation 505, the function RTOHC_DOCUMENT_CREATE then calls another function K_SURCHARGE_CALCULATE to calculate the overhead, save the calculated overhead document locally in memory. In operation 506, the method CREATE of class CL_FINS_RTOHC_DOC (e.g., to which the overhead document is returned) then calls function RTOHC_DOCUMENT_CHECK in a separate LUW (Logical Unit of Work) to validate the real-time overhead document calculated in step 505. In operation 507, the function RTOHC_DOCUMENT_CHECK passes the real-time overhead document to function K_SURCHARGE_CALCULATE to perform the check. In operation 508, the function K_SURCHARGE_CALCULATE triggers the process K-BELEG and event PRUEFFEN of the accounting interface RWIN to perform the check.

In regard to FIG. 5B, at operation 509, if there were no errors in previous steps, the process BELEG and event POST of the accounting interface RWIN will be triggered to do the posting. In operation 510, the accounting interface RWIN calls function CO_DOCUMENT_POST to post the CO documents created just now. In operation 511, the function CO_DOCUMENT_POST first posts the CO document (for a primary posting), and then calls method POST of class CL_FINS_RTOHC_DOC within the subroutine DOCUMENT_POST. In operation 512, the method POST of class CL_FINS_RTOHC_DOC then calls function RTOHC_DOCUMENT_POST to post the real-time overhead document. In operation 513, the function RTOHC_DOCUMENT POST passes the real-time overhead document calculated in step 505 to the function K_SURCHARGE_CALCULATE to do the posting. Finally at operation 514 The function K_SURCHARGE_CALCULATE then trigger the process K-BELEG and events PRUEFFEN and FERTIG of the accounting interface RWIN to perform the final posting of the real-time overhead document.

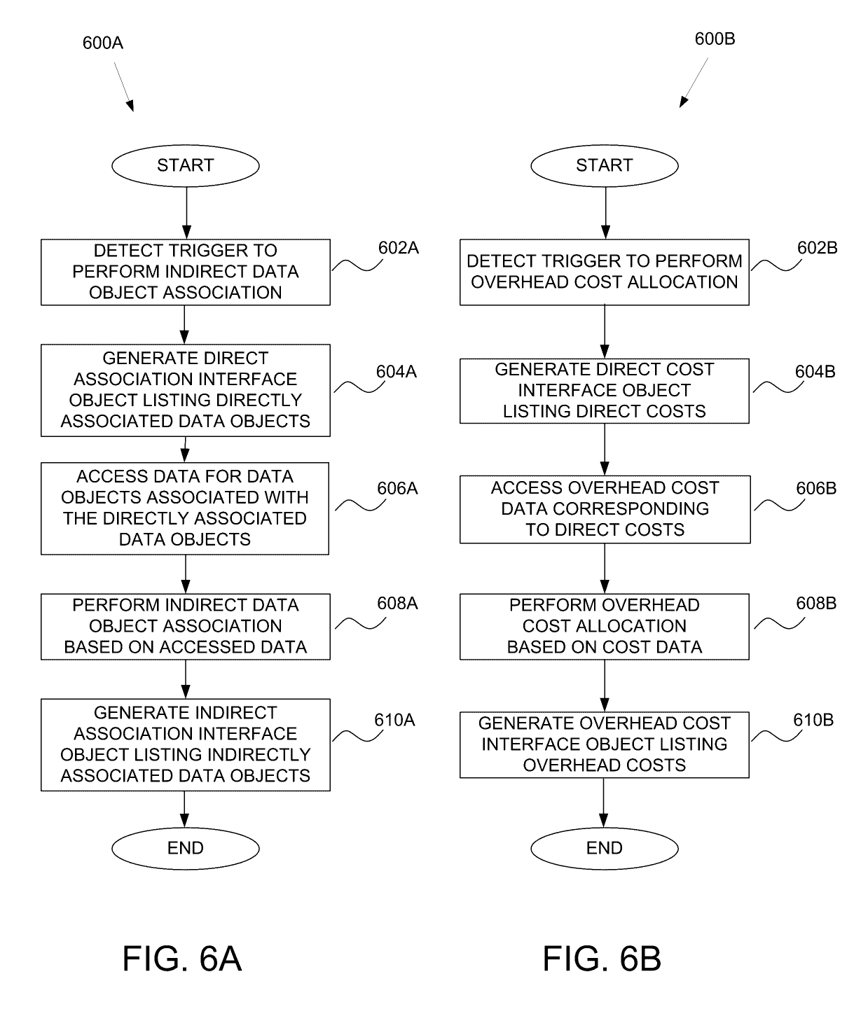

FIGS. 6A and 6B are flowcharts of an example methods, in accordance with example embodiments, for providing real-time data object associations and real-time overhead cost allocations respectively

FIG. 6A is a flowchart of an example method 600A for providing a real-time data object associations. In operation 602A, a data object association module detects a trigger to perform an indirect data object association based on a user's interaction with a user interface for determining data object associations for a selected data object. In operation 604A, the data object association module then generates a direct association interface object listing data objects that are directly associated with the selected data object. In operation 606A, data corresponding to data objects associated with the data objects directly associated with the selected data object (e.g., listed in the direct association interface object) is accessed. In other words, data corresponding to data objects that are only indirectly related to the selected data object (e.g., overhead costs) is accessed.

In operation 608A, the data object association module then performs the indirect data object association based on the selected data object, the data objects directly associated with the selected data object and the accessed data. In operation 610A, the data object association module then generates an indirect association interface object to list data objects that are indirectly associated with the selected data object based on the performed indirect data object association.

FIG. 6B is a flowchart of an example method 600B for providing a real-time overhead cost allocations. The method 600B is described using the overhead cost allocation module 106 of FIG. 3. In operation 602B, the overhead cost allocation module 106 (e.g., via cost estimate framework 320) detects a trigger to perform an overhead cost allocation based on a user's interaction with a graphical user interface 200 (e.g., of business system 102) for determining a total cost of producing a product or providing a service. The trigger might be, for example, a user allocation of a direct cost (e.g., raw material cost) to the total cost of producing the product.

In operation 604B, the overhead cost allocation module 106 then generates a direct cost interface object 210 accessible in the graphical user interface 200. The direct cost interface object 210 lists the costs directly attributable to the production of the product. For example, the data regarding the direct costs may be retrieved from transactional and overhead data storage 330 where it has been assembled via queries to modules of the business system 102 (or queries to the user) generated by the cost estimate framework 320.

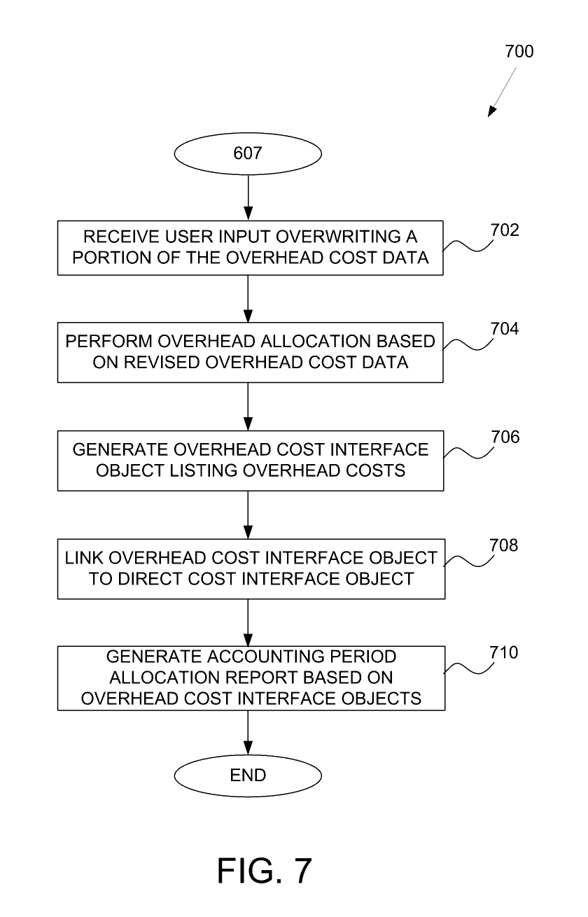

In operation 606B, overhead cost data corresponding to the direct costs listed in the direct cost interface object 210 is assembled in transactional and overhead data storage 330. The assembly may be performed by the cost estimate framework 320 as described above with respect to the direct costs. Operation 606B is discussed in more detail in connection with FIG. 7 below.

In operation 608B, the overhead cost allocation module 106 then performs the overhead cost allocation (e.g., via allocation engine 340) based on the direct costs associated with producing the product and the corresponding overhead cost data as stored in transactional and overhead data storage 330.

In operation 610B, the overhead cost allocation module 106 then generates an overhead cost interface object 220 (e.g., accessible via the overhead cost override UI 310) to list overhead costs associated with producing the product.

FIG. 7 is a flowchart of an example method 700 for providing real-time overhead cost allocations. The method 700 is described using the overhead cost allocation module 106 of FIG. 3 and begins from operation 506 of FIG. 5. In operation 702, the overhead cost allocation module 106 (e.g., via the overhead cost override UI 310) detects a user input trigger to overwrite some portion of the overhead cost data corresponding to the direct costs listed in the direct cost interface object 210. For example, the user may modify the rate at which an overhead cost (e.g., equipment depreciation) is allocated to a direct cost listed in the direct cost interface object 210.

In operation 704, the overhead cost allocation module 106 then performs the overhead cost allocation (e.g., via allocation engine 340) based on the direct costs associated with producing the product and the user revised corresponding overhead cost data which is also stored in transactional and overhead data storage 330.

In operation 706, the overhead cost allocation module 106 then generates an overhead cost interface object 220 (e.g., accessible via the overhead cost override UI 310) to list overhead costs associated with producing the product.

In operation 708, the overhead cost allocation module 106 then links (e.g., via allocation engine 340) the overhead cost interface object 220 to the direct cost interface object 210 for easy future reference in regard to the total cost of producing the product for which the direct and overhead costs are listed in each of the respective interface objects such as objects 210 and 220 of FIG. 2. The linked interface objects may then be saved (e.g., to system storage 104) together within one logical data structure to ensure that the linked interface objects are only manipulated (e.g., checking or editing) together or not at all. In this way, errors resulting from uncoordinated manipulation of related data objects can be avoided.

In operation 710, the overhead cost allocation module 107 then generates an overhead cost allocation report for multiple products produced during an accounting period (e.g., required financial accounting) based on overhead costs listed in the respective real-time overhead cost allocations of the multiple products. These overhead costs are indicated in each of the respective overhead cost interface objects 220 linked to the direct cost interface objects 210 for transactions (e.g., direct cost allocations) related to the multiple products produced during the accounting period.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein may, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or a server farm), while in other example embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments can be implemented in digital electronic circuitry, or in computer hardware, firmware, software, or combinations of these. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware can be a design choice. Below are set out hardware (e.g., machine) and software architectures that can be deployed, in various example embodiments.

### Machine Architecture and Machine-Readable Medium

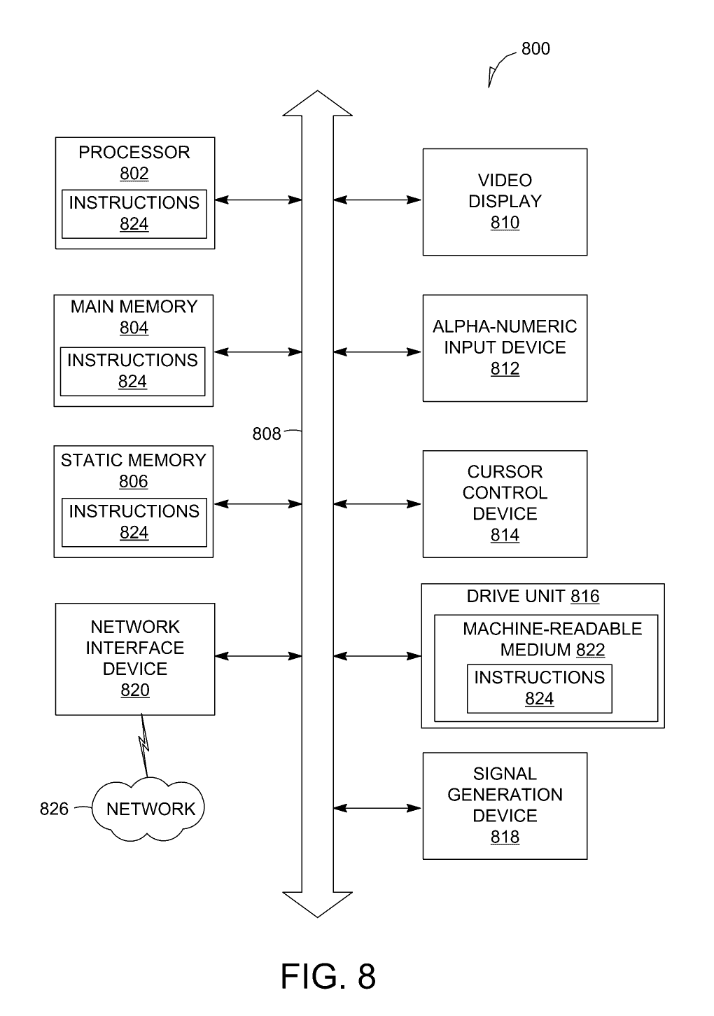

FIG. 8 is a block diagram of a machine in the example form of a computer system 800 within which instructions for causing the machine to perform any one or more of the methodologies discussed herein can be executed. In alternative embodiments, the machine can operate as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 can further include a video display unit 810 (e.g., a liquid crystal display (LCD) or a cathode ray tube (CRT)). The computer system 800 can also include an alpha-numeric input device 812 (e.g., a keyboard or a touch-sensitive display screen), a user interface (UI) navigation device 814 (e.g., a mouse), a drive unit 816, a signal generation device 818 (e.g., a speaker), and a network interface device 820.

### Machine-Readable Medium

The disk drive unit 816 includes a computer-readable medium 822 on which is stored one or more sets of instructions and data structures (e.g., software) 824 embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media 822.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions 824 for execution by the machine and that cause the machine to perform any one or more of the methodologies of the present disclosure, or that is capable of storing, encoding or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a machine including one or more hardware processors;
a data object association module configured to:
detect a trigger to perform an indirect data object association based on a user interaction with a user interface of the machine, the interface for determining data objects associated with a selected data object;
generate a direct association interface object that lists data objects directly associated with the selected data object;
access data corresponding to data objects directly associated with the data objects listed in the direct association interface object;
perform, using the one or more hardware processors, the indirect data object association based on the selected data object, the data objects directly associated with the selected data object and the corresponding indirect association data; and
generate an indirect association interface object to list data objects indirectly associated with the selected data object.

2. The system of claim 1, wherein the data object association module is further configured to link the indirect association interface object to the direct association interface object.

3. The system of claim 1, wherein:
the selected data object represents a product;
the data objects directly associated with the selected data object represent direct costs associated with producing the product;
the data objects directly associated with the data objects listed in the direct association interface object represent overhead costs associated with the direct costs associated with producing the product; and
the accessed data is overhead cost data and the indirect data object association comprises an overhead cost allocation.

4. The system of claim 3, wherein the data object association module is further configured to receive input from the user overwriting or replacing a portion of the overhead cost data for use in the overhead cost allocation.

5. The system of claim 3, wherein the data object association module is further configured to perform the overhead cost allocation by applying a percentage-based or quantity-based overhead rate to each of the direct costs listed by the direct association interface object.

6. The system of claim 5, wherein the overhead cost data comprises overhead costs that are applicable to at least one of the direct costs listed by the direct cost interface object and a specified percentage-based or quantity-based overhead rate at which each of the overhead costs is applied.

7. The system of claim 3, wherein the user interface allows for a group of users to collaboratively provide input for overwriting or replacing a portion of the overhead cost data for use in the overhead cost allocation.

8. The system of claim 1, wherein the data object association module is further configured to generate a periodic indirect data object association report for multiple selected data objects based on the data objects listed in each of the respective indirect association interface objects generated with respect to the multiple selected data objects during a specified recurring time period.

9. The system of claim 3, wherein the data object association module is further configured to generate an overhead cost allocation report for multiple products produced during an accounting period based on the overhead costs listed in each of the respective indirect association interface objects generated with respect to the multiple products during the accounting period.

10. A method comprising:
detecting a trigger to perform an indirect data object association based on a user interaction with a user interface of the machine, the interface for determining data objects associated with a selected data object;
generating a direct association interface object that lists data objects directly associated with the selected data object;
accessing data corresponding to data objects directly associated with the data objects listed in the direct association interface object;
performing, using one or more hardware processors of the machine, the indirect data object association based on the selected data object, the data objects directly associated with the selected data object and the corresponding indirect association data; and
generating an indirect association interface object to list data objects indirectly associated with the selected data object.

11. (canceled)

12. The method of claim 10, wherein:
the selected data object represents a product;
the data objects directly associated with the selected data object represent direct costs associated with producing the product;
the data objects directly associated with the data objects listed in the direct association interface object represent overhead costs associated with the direct costs associated with producing the product; and
the accessed data is overhead cost data and the indirect data object association comprises an overhead cost allocation.

13. (canceled)

14. The method of claim 12, further comprising performing the overhead cost allocation by applying a percentage-based or quantity-based overhead rate to each of the direct costs listed by the direct association interface object.

15. The method of claim 14, wherein the overhead cost data comprises overhead costs that are applicable to at least one of the direct costs listed by the direct cost interface object and a specified percentage-based or quantity-based overhead rate at which each of the overhead costs is applied.

16. The method of claim 12, wherein the user interface allows for a group of users to collaboratively provide input for overwriting or replacing a portion of the overhead cost data for use in the overhead cost allocation.

17. The method of claim 10, further comprising generating a periodic indirect data object association report for multiple selected data objects based on the data objects listed in each of the respective indirect association interface objects generated with respect to the multiple selected data objects during a specified recurring time period.

18. The method of claim 12, further comprising generating an overhead cost allocation report for multiple products produced during an accounting period based on the overhead costs listed in each of the respective indirect association interface objects generated with respect to the multiple products during the accounting period.

19. A non-transitory machine-readable storage medium storing instructions which, when executed by at least one processor of a machine, cause the machine to perform operations comprising:
detecting a trigger to perform an indirect data object association based on a user interaction with a user interface of the machine, the interface for determining data objects associated with a selected data object;
generating a direct association interface object that lists data objects directly associated with the selected data object;
accessing data corresponding to data objects directly associated with the data objects listed in the direct association interface object;
performing, using one or more hardware processors of the machine, the indirect data object association based on the selected data object, the data objects directly associated with the selected data object and the corresponding indirect association data; and
generating an indirect association interface object to list data objects indirectly associated with the selected data object.

20. The machine-readable storage medium of claim 19, wherein:
the selected data object represents a product;
the data objects directly associated with the selected data object represent direct costs associated with producing the product;
the data objects directly associated with the data objects listed in the direct association interface object represent overhead costs associated with the direct costs associated with producing the product; and
the accessed data is overhead cost data and the indirect data object association comprises an overhead cost allocation.

21. The machine-readable storage medium of claim 19, the operations further comprising generating a periodic indirect data object association report for multiple selected data objects based on the data objects listed in each of the respective indirect association interface objects generated with respect to the multiple selected data objects during a specified recurring time period.

22. The machine-readable storage medium of claim 20, the operations further comprising generating an overhead cost allocation report for multiple products produced during an accounting period based on the overhead costs listed in each of the respective indirect association interface objects generated with respect to the multiple products during the accounting period.
